(19) United States
(12) Patent Application Publication
(10) Pub. No.: US 2014/0209684 A1
(43) Pub. Date: Jul. 31, 2014

(54) METHOD AND INFORMATION CARRIER FOR DISSEMINATING AND/OR RELAYING INFORMATION

(71) Applicant: Wolfgang Hammer, Wiesloch (DE)

(72) Inventor: Wolfgang Hammer, Wiesloch (DE)

(21) Appl. No.: 14/238,869

(22) PCT Filed: Aug. 19, 2011
(86) PCT No.: PCT/DE2011/001631

§ 371 Date: Feb. 20, 2014

(30) Foreign Application Priority Data
Aug. 16, 2011 (DE) 10 2011 110 201.2

(51) Int. Cl. G06K 7/14

(52) U.S. Cl. CPC G06K 7/1417
USPC 235/462.1

(57) ABSTRACT

A method for disseminating and/or relaying a piece of information, wherein a packaging of a foodstuff or drink comprises a code, in particular a QR code, wherein the code is read and processed by an addressable reader, in particular a mobile radio device, smart phone, PDA, portable media player or similar, and wherein an operation defined by the code is triggered on the reader, said operation entailing a response addressed to the reader. Moreover, a corresponding information carrier is disclosed.

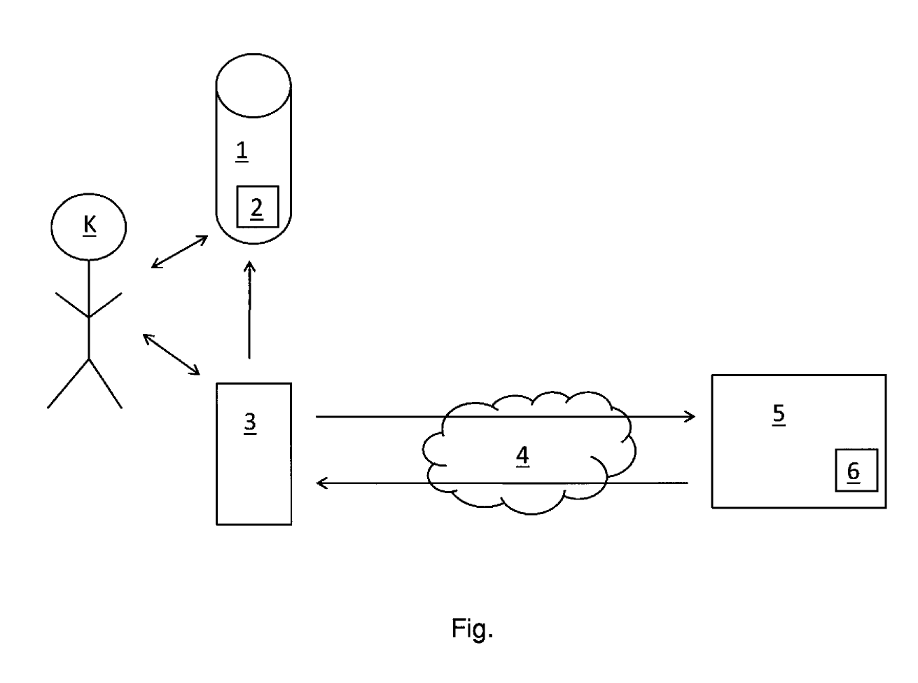

### CROSS REFERENCE TO RELATED APPLICATIONS

This application is a national stage application, filed under 35 U.S.C. §371, of International Application No. PCT/DE2011/001631, filed Aug. 19, 2011, which claims priority further to German Application No. 10 2011 110 201.2, filed Aug. 16, 2011, the contents of all of which are hereby incorporated by reference in their entirety.

### BACKGROUND

1. Technical Field

The invention relates to a method for disseminating and/or relaying a piece of information. Furthermore, the invention relates to an information carrier for disseminating and/or relaying a piece of information.

2. Description of Related Art

According to patent claim 1, the packaging of a foodstuff or drink enables the placement or display of a code. Insofar, it should be added that the terms foodstuff and drink shall be interpreted in the broadest sense, namely to the extent that they equally include stimulants such as tobacco and miscellaneous alcoholic beverages. As a result, the reference to foodstuffs and drinks shall not represent a limitation within the meaning of the claimed teaching.

Generally, this concerns the relaying or disclosure of information with respect to a specific product to be conveyed to a potential consumer of the product. As an example, the specific product can be a certain type of merchandise or service.

Methods and information carriers of the mentioned type have been known in the practice for years. Accordingly, information about a specific product can be communicated to the potential consumer by way of posters, flyers, print media, video displays, etc. In the practice, the potential consumer is often offered possibilities to obtain additional, detailed information about the specific product. For instance, a website can be listed on a poster, from which the consumer can obtain additional information. However, the drawback of this solution is that the consumer—if he is interested in the specific product—is required to write down the website address and later enter it in a device that can be connected to the internet. This is cumbersome and annoying for the prospective consumer.

### BRIEF SUMMARY

Therefore, the object of the present invention is to design a method and an information carrier for disseminating and/or relaying a piece of information such that an effective dissemination of the information can be achieved with simple constructional means.

According to the invention, the object mentioned above is solved with the characteristics of patent claim 1. Accordingly, a method for disseminating and/or relaying a piece of information is disclosed, wherein a packaging of a foodstuff or drink comprises a code, in particular a QR code, wherein the code is read and processed by an addressable reader, in particular a mobile radio device, smart phone, PDA, portable media player or similar, and wherein an operation defined by the code is triggered on the reader, said operation entailing a response addressed to the reader.

With respect to the information carrier according to the invention, the object mentioned above is solved with the characteristics of patent claim 11. Accordingly, an information carrier for disseminating and/or relaying a piece of information is disclosed, comprising a packaging and a foodstuff or drink wrapped in the packaging, wherein the packaging comprises a code, in particular a QR code, wherein the code can be read and processed by an addressable reader, in particular a mobile radio device, smart phones, PDA, portable media player or similar, and wherein the code triggers an operation on the reader, said operation entailing a response addressed to the reader.

According to the present invention, it was determined as a start that it is of considerable advantage if the relaying of the information is linked to a consumer good the potential consumer is interested in, such as a foodstuff or drink. In the practice, the information is disseminated or relayed by way of the packaging of a foodstuff, a drink or stimulant serving as information carrier. For this purpose, the packaging comprises a code. Ideally, a QR code (quick response code) or similar two-dimensional codes are used as code. Secondly, it was determined based on the present invention, that the annoying writing down of the information by the consumer can be prevented if the code is read and processed by a reader. Any mobile devices with a camera can be used as readers, such as for example common mobile radio devices, smart phones, PDAs (Personal Digital Assistants), portable media players or similar. Once the reader has processed or decoded the code, an operation or action defined by the code is triggered on the reader, said operation or action entailing a response addressed to the reader. The operation can be a process comprising a plurality of operational steps. Ideally, a software application for the reader is provided for processing the code and for subsequently triggering the operation/action.

As a result, the method according to the invention and the information carrier according to the invention enable an effective dissemination of the information with simple constructional means.

In a particularly advantageous fashion, the packaging can be used as information carrier for a piece of information in regards to a specific product, for example a certain type of merchandise or a specific service.

In a further advantageous fashion, the operation can comprise the set-up of an internet connection by way of a wireless interface, preferably by means of WLAN (Wireless Local Area Network), UMTS (Universal Mobile Telecommunications System), EDGE (Enhanced Data Rates for GSM Evolution), HSDPA (High Speed Downlink Packet Access), GPRS (General Packet Radio Service), LTE (3GPP Long Term Evolution), etc.

In an advantageous embodiment, the reader can correspond with a server via the internet, for example with a database server or web server, whereby the code comprises an identification address to address the server. A Uniform Resource Identifier (URI) is conceivable herein as identification address, which represents an identifier and consists of a character string used to identify an abstract or physical resource. Thus, resources can be addressed, such as for example websites, other files and/or web services on the internet.

For one specific embodiment, a program for the reader can be loaded via the internet and installed on the reader based on the processed code within the scope of the operation. In the practice, the program can be a program with a direct correlation to a specific product or a specific service. For instance, it is conceivable that the products or services of a fitness studio can be supported to the extent that the program provides a training application for the visit of the fitness studio.

With respect to the provision of detailed information about a specific product, a website can be retrieved and displayed on the reader within the scope of the operation. Consequently, the consumer automatically obtains additional information about a product he is interested in by scanning the code.

In a further advantageous fashion, a song, movie, video clip, etc. can be loaded via the internet and displayed on the reader within the scope of the operation.

To promote the potential consumer's interest in a product, specific sentiments or emotions can be evoked in the potential consumer of the foodstuff or drink by adding aromas, in particular flavors and/or fragrances to the foodstuff or drink. In the practice, the aromas of the foodstuff or drink, i.e., their ingredients can be selected in such a way that they evoke the specific intended or desired sentiments or emotions in the consumer.

In the practice, the aromas are selected such that they draw the consumer's attention to the packaging due to the evoked sentiments and emotions, and hence to the code placed thereon.

In a further advantageous fashion, the aromas can be selected in view of the characteristics of the prospective or potential consumer. As a result, the aromas can be targeted directly to the characteristics of the potential consumer as target person. Conceivable options include characteristics such as male, female, young and/or old.

Different possibilities are available to design and upgrade the teaching of the present invention in an advantageous fashion. For this purpose, reference is made to the subordinate claims of patent claim 1 on the one hand and the explanation of a preferred exemplary embodiment of the invention based on the drawing on the other hand. In connection with the explanation of the preferred exemplary embodiment of the invention based on the drawing, generally preferred embodiments and upgrades of the teaching are explained as well.

### DETAILED DESCRIPTION OF THE DRAWING

In the sole drawing, the FIGURE (FIGURE) shows a schematic representation of an exemplary embodiment of the method according to the invention and the information carrier according to the invention.

### DETAILED DESCRIPTION OF VARIOUS EMBODIMENTS

The sole FIGURE shows a schematic representation of the basic function of the method according to the invention, according to which a code 2 in the form of a QR code is printed onto a packaging 1. The packaging 1 is wrapped around a drink that is not illustrated in the sole FIGURE. The code 2 on the packaging 1 is read and processed by the consumer K by means of the reader 3.

After decoding the code 2, the reader 3 receives a web address of a website 6 coded in the code 2 and performs the operation defined by the code 2.

The reader 3 can display a message to provide the consumer K with the option to allow or disallow the performance of the operation.

If the consumer K allows the performance of the operation, the reader 3 automatically establishes a connection with a server 5 in the form of a web server via the internet 4, based on the decoded web address that is coded in the code 2. The server 5 then transmits the requested data, for example a website 6, to the reader 3 via the internet 4. The website 6 can be viewed by the consumer K on a display or a display device of the reader 3.

Thus, it should be understood that an object of the present invention is to design a method and an information carrier for disseminating and/or relaying a piece of information such that an effective dissemination of the information can be achieved with simple constructional means.

According to the invention, the object mentioned above is solved with the characteristics of patent claim 1. Accordingly, a method for disseminating and/or relaying a piece of information is disclosed, wherein a packaging of a foodstuff or drink comprises a code, in particular a QR code, wherein the code is read and processed by an addressable reader, in particular a mobile radio device, smart phone, PDA, portable media player or similar, and wherein an operation defined by the code is triggered on the reader, said operation entailing a response addressed to the reader.

With respect to the information carrier according to the invention, the object mentioned above is solved with the characteristics of patent claim 11. Accordingly, an information carrier for disseminating and/or relaying a piece of information is disclosed, comprising a packaging and a foodstuff or drink wrapped in the packaging, wherein the packaging comprises a code, in particular a QR code, wherein the code can be read and processed by an addressable reader, in particular a mobile radio device, smart phones, PDA, portable media player or similar, and wherein the code triggers an operation on the reader, said operation entailing a response addressed to the reader.

According to the present invention, it was determined as a start that it is of considerable advantage if the relaying of the information is linked to a consumer good the potential consumer is interested in, such as a foodstuff or drink. In the practice, the information is disseminated or relayed by way of the packaging of a foodstuff, a drink or stimulant serving as information carrier. For this purpose, the packaging comprises a code. Ideally, a QR code (quick response code) or similar two-dimensional codes are used as code. Secondly, it was determined based on the present invention, that the annoying writing down of the information by the consumer can be prevented if the code is read and processed by a reader. Any mobile devices with a camera can be used as readers, such as for example common mobile radio devices, smart phones, PDAs (Personal Digital Assistants), portable media players or similar. Once the reader has processed or decoded the code, an operation or action defined by the code is triggered on the reader, said operation or action entailing a response addressed to the reader. The operation can be a process comprising a plurality of operational steps. Ideally, a software application for the reader is provided for processing the code and for subsequently triggering the operation/action.

As a result, the method according to the invention and the information carrier according to the invention enable an effective dissemination of the information with simple constructional means.

In a particularly advantageous fashion, the packaging can be used as information carrier for a piece of information in regards to a specific product, for example a certain type of merchandise or a specific service.

In a further advantageous fashion, the operation can comprise the set-up of an internet connection by way of a wireless interface, preferably by means of WLAN (Wireless Local Area Network), UMTS (Universal Mobile Telecommunications System), EDGE (Enhanced Data Rates for GSM Evolution), HSDPA (High Speed Downlink Packet Access), GPRS (General Packet Radio Service), LTE (3GPP Long Term Evolution), etc.

In an advantageous embodiment, the reader can correspond with a server via the internet, for example with a database server or web server, whereby the code comprises an identification address to address the server. A Uniform Resource Identifier (URI) is conceivable herein as identification address, which represents an identifier and consists of a character string used to identify an abstract or physical resource. Thus, resources can be addressed, such as for example websites, other files and/or web services on the internet.

For one specific embodiment, a program for the reader can be loaded via the internet and installed on the reader based on the processed code within the scope of the operation. In the practice, the program can be a program with a direct correlation to a specific product or a specific service. For instance, it is conceivable that the products or services of a fitness studio can be supported to the extent that the program provides a training application for the visit of the fitness studio.

With respect to the provision of detailed information about a specific product, a website can be retrieved and displayed on the reader within the scope of the operation. Consequently, the consumer automatically obtains additional information about a product he is interested in by scanning the code.

In a further advantageous fashion, a song, movie, video clip, etc. can be loaded via the internet and displayed on the reader within the scope of the operation.

To promote the potential consumer's interest in a product, specific sentiments or emotions can be evoked in the potential consumer of the foodstuff or drink by adding aromas, in particular flavors and/or fragrances to the foodstuff or drink. In the practice, the aromas of the foodstuff or drink, i.e., their ingredients can be selected in such a way that they evoke the specific intended or desired sentiments or emotions in the consumer.

In the practice, the aromas are selected such that they draw the consumer's attention to the packaging due to the evoked sentiments and emotions, and hence to the code placed thereon.

In a further advantageous fashion, the aromas can be selected in view of the characteristics of the prospective or potential consumer. As a result, the aromas can be targeted directly to the characteristics of the potential consumer as target person. Conceivable options include characteristics such as male, female, young and/or old.

Different possibilities are available to design and upgrade the teaching of the present invention in an advantageous fashion. For this purpose, reference is made to the subordinate claims of patent claim 1 on the one hand and the explanation of a preferred exemplary embodiment of the invention based on the drawing on the other hand. In connection with the explanation of the preferred exemplary embodiment of the invention based on the drawing, generally preferred embodiments and upgrades of the teaching are explained as well.

Finally, it is pointed out explicitly that the exemplary embodiment of the method according to the invention and the information carrier according to the invention described above is intended exclusively to provide an explanation of the claimed teaching without restricting it to the exemplary embodiment.

### REFERENCE LIST

1 Packaging

2 Code

3 Reader

4 Internet

5 Server

6 Website

K Consumer

1-11. (canceled)

12. A method for at least one of disseminating or relaying a piece of information, wherein a packaging (1) of a foodstuff or drink comprises a code (2), in particular a QR code, wherein the code (2) is read and processed by an addressable reader (3), and wherein an operation defined by the code is triggered on the reader (3), said operation entailing a response addressed to the reader (3).

13. A method according to claim 12, wherein the addressable reader (3) comprises at least one of a mobile radio device, a smart phone, a PDA, or a portable media player.

14. A method according to claim 12, wherein the packaging (1) is used as information carrier for a piece of information with regard to at least one of a specific product or a specific service.

15. A method according to claim 12, wherein the operation comprises the set-up of an internet connection via a wireless interface.

16. A method according to claim 15, wherein the wireless interface comprises at least one of WLAN, UMTS, EDGE, HSDPA, GPRS, or LTE.

17. A method according to claim 12, wherein:
the reader (3) corresponds (4) with a server (5) via the internet; and
the code (2) comprises an identification address to address the server (5).

18. A method according to claim 17, wherein the server is at least one of a database server or a web server.

19. A method according to claim 12, wherein a program is loaded via the internet (4) and installed on the reader (3) within the scope of the operation.

20. A method according to claim 12, wherein a website is retrieved and displayed on the reader (3) within the scope of the operation.

21. A method according to claim 12, wherein at least one of a song, a movie, or a video clip is loaded via the internet (4) and displayed on the reader (3) within the scope of the operation.

22. A method according to claim 12, wherein specific sentiments and emotions are evoked in the consumer (K) of the foodstuff or drink via aromas.

23. A method according to claim 12, wherein the aromas comprise at least one of particular flavors or particular fragrances added to the foodstuff or drink.

24. A method according to claim 22, wherein the aromas are selected such that they attract the consumer's (K) attention to the packaging (1) in response to the evoked sentiments or emotions.

25. A method according to claim 22, wherein the aromas are selected in view of the characteristics of a prospective consumer (K).

26. A method according to claim 25, wherein the aromas are selected in view of characteristics such as male, female, young and/or old.

27. An information carrier for at least one of disseminating or relaying a piece of information, in particular for the conduct of a method according to claim 12, having a packaging (1) and a foodstuff or drink wrapped in the packaging (1), wherein a code (2), in particular a QR code is placed on the packaging (1), wherein the code (2) can be read and processed by an addressable reader (3), and wherein the code (2) triggers an operation on the reader (3), said operation entailing a response addressed to the reader (3).

28. An information carrier according to claim 27, wherein the addressable reader (3) comprises at least one of a mobile radio device, a smart phone, a PDA, or a portable media player.
